(19) United States
(12) Patent Application Publication
(10) Pub. No.: US 2006/0166540 A1
(43) Pub. Date: Jul. 27, 2006

(54) Flexible flat cable

(75) Inventors: Yung-Lu Wu, Taipei (TW); Song-Feng Yang, Tao Yuan Shien (TW); Kuo-Chang Lin, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/269,089

(22) Filed: Nov. 8, 2005

(30) Foreign Application Priority Data
Jan. 25, 2005 (TW) 94102192

(51) Int. Cl. H01R 13/15

(52) U.S. Cl. 439/260

(57) ABSTRACT

A flexible flat cable is used for plugging into a socket. The socket includes an actuator border and a concave border. The actuator border and the concave border form a slot. The flexible flat cable includes a body and a guider. The body has a top surface and a bottom surface. The body has a conductive portion disposed on the top surface and extends to the edge of the body. The guider disposed on the top surface of the body is used to be against to the concave border to make the conductive portion inserting into the slot for being electrically connected to the socket.

This application claims the benefit of Taiwan application Serial No. 94102192, filed Jan. 25, 2005, the subject matter of which is incorporated herein by reference.

### BACKGROUND OF THE INVENTION

1. Field of the Invention

The invention relates to a flexible flat cable (FFC), and more particularly to a flexible flat cable, which is plugged into the socket.

2. Description of the Related Art

The electronic products have become essential and omnipresent in our daily life. For example, mobile phones, computers, scanner and printers are all in the category of electronic products. However, many electronic products are very sensitive, so exceptional caution needs to be taken when using or assembling these products; otherwise, some unexpected incidents will happen and cause damages to these products. Taking the notebook as an example, an inappropriate connection between the flexible flat cable and the socket breaks the transmission of the signals, which further affects the normal functions of the whole.

Referring to FIG. 1A, a schematic diagram illustrates the flexible flat cable obliquely plugged into the socket. When plugging the flexible flat cable 101 into the socket 102, an uneven force applied by users results in an incline at one end of the flexible flat cable 101. Consequently, the flexible flat cable 101 could not transmit signals due to part of the conductors failing to contact with the corresponding electric action point 30. And serious crash might be happened because of the signal transmission errors. FIG. 1B is a cross-sectional view of the flexible flat cable, illustrating the flexible fate cable incompletely plugged into the socket. The dotted line represents the electric action point 30 of the incomplete contact. As plugging the flexible flat cable 101 through the front side 101a into the socket 102, the insufficient applied force causes the partial touch or separation from the electric action point 30. Accordingly, the connection between the flexible flat cable 101 and the socket 102 is incomplete. FIG. 1C shows the flexible flat cable 101 reversely plugged into the socket. When the flexible flat cable 101 is plugged into the socket 102 through the reverse side 101b, because the aperture of the socket 102 is the same and the size of every conductor located at one end of the flexible flat cable is the same, users are likely to plug the flexible flat cable 101 into the socket 102 reversely by mistake. Therefore, the consequences might be the unfit construction, which disables the flexible flat cable 101 from being completely plugged into the electric action point 30, or even make the flexible flat cable 101 unable to function properly. In the above-mentioned situations, the electronic products fail to function properly because of the incompletely transmitted signals. Especially, when the flexible flat cable 101 is reversely or obliquely plugged into the socket 102, signal transmission errors bring the damage to the socket or the flexible flat cable, and even cause fire accident to endanger people's safety.

### SUMMARY OF THE INVENTION

It is therefore an object of the invention to provide a flexible flat cable, which enables the users to plug the flexible flat cable flush and appropriately into the socket. Therefore, the signal transmission errors or transmission breaking off caused by personal undue operation can be prevented. This invention further avoids accidents, which endanger our safety.

The invention achieves the above-identified object by providing a flexible flat cable, which includes a body and a guider The flexible flat cable is used to be plugged into the socket. The socket includes an actuator border and a concave border, which form a slot. The body has a top surface, a bottom surface, and a conductor. The conductor is disposed on the top surface of the body and extends to the end edge of the body. The guider is disposed on the top surface of the body. When the guider is against the concave border, the conductive portion is inserted into the socket completely for being electrically connected to the socket.

The invention achieves the above-identified object by further providing a connecting apparatus, which includes a socket and a flexible flat cable. The socket includes the actuator border and the concave border, which form a slot. The flexible flat cable is plugged into the socket and includes the body and the guider. The body has the top surface, the bottom surface, and a conductive portion. The conductive portion is disposed on the top surface and extends to the end edge of the body. The guider is disposed on the top surface of the body. When the guider is against to the concave border, the conductive portion is inserted into the slot completely for being electrically connected to the socket.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a schematic diagram illustrating a flexible flat cable obliquely plugged into the socket.

FIG. 1B (Prior Art) is a cross-sectional view of the flexible flat cable incompletely plugged into the socket.

FIG. 1C (Prior Art) is a schematic diagram illustrating the flexible flat cable reversely plugged into the socket.

FIG. 2A is a perspective view of the connecting apparatus.

FIG. 2B is a lateral view of the flexible flat cable.

FIG. 2C is a top view of the flexible flat cable.

FIG. 2D is a bottom view of the flexible flat cable.

FIG. 3A is a lateral cross-sectional view of the socket.

FIG. 3B is a top view of the socket.

FIG. 3C is a lateral cross-sectional view of the flexible flat cable plugged into the socket.

FIG. 3D is a lateral cross-sectional view of the flexible flat cable reversely plugged into the socket.

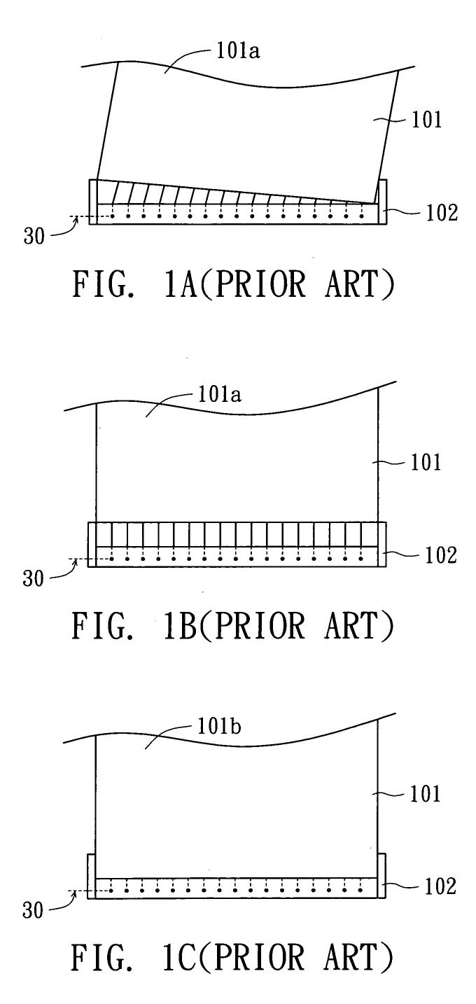

### DETAILED DESCRIPTION OF THE INVENTION

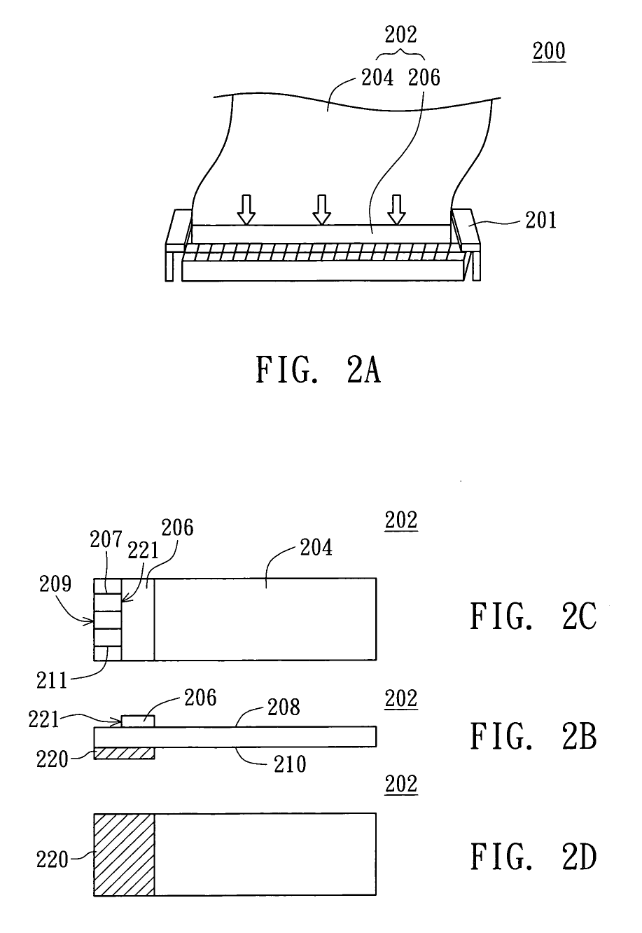

Referring to FIG. 2A, a cross-sectional view of a connecting apparatus is shown. The connecting apparatus 200 includes a socket 201 and a flexible flat cable 202. The flexible flat cable 202 is plugged into the socket 201 along the direction of the arrow depicted in the FIG. 2A. The flexible flat cable 202 includes the body 204, and the guider 206. Referring to FIG. 2B, a lateral view of the flexible flat cable is shown. The body of the flexible flat cable 202 has the top surface 208 and the bottom surface 210. The guider 206 is a rigid body, which could be made of plastic. The guider 206 is fixed on the top surface 208 of the body 204 by an adhesive. The guider 206 has a bearing surface, which is parallel to the end edge 209 of the body 204 substantially. Accordingly, the end edge 209 of the body 204 is flush plugged into the socket 201 as shown in FIG. 2A.

Referring to FIG. 2C, a top view of the flexible flat cable is shown. The conductive portion 207 of the body 204 is disposed on the top surface 208 of the body 204 and extends to the end edge 209 of the body 204. The conductive portion 207 includes a plurality of conductors 211, which is exposed outside the body 204. Referring to FIGS. 2C, and 2D, FIG. 2D is the bottom view of the flexible flat cable. The flexible flat cable 202 further has a supporting portion 220 disposed on the bottom surface 210. The supporting portion 220 such as an insulation tape is substantially corresponding to the conductive portion 207 and the guider 206 of the top surface 208. The double sided supporting of the supporting portion 220 and the guider 206 enable the flexible flat cable 202 being plugged into the socket 201 smoothly.

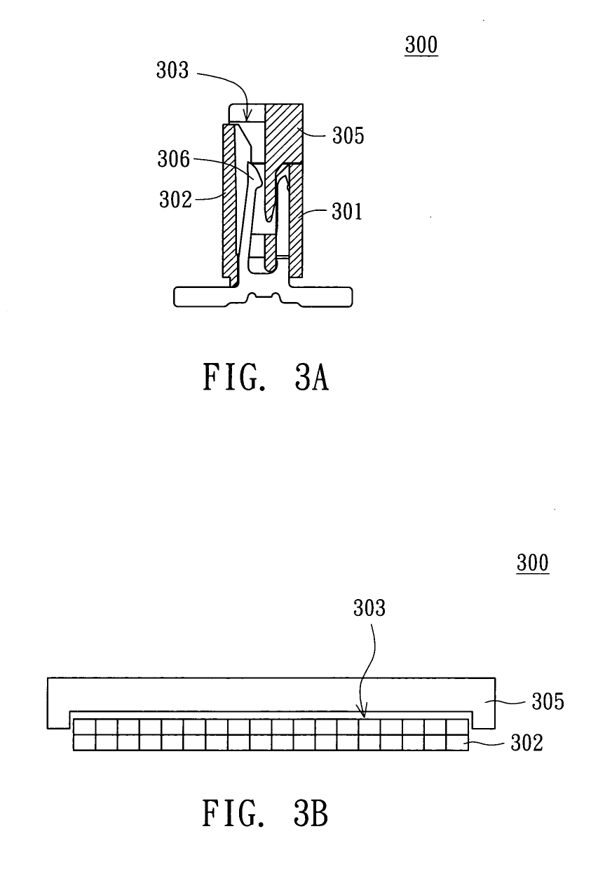

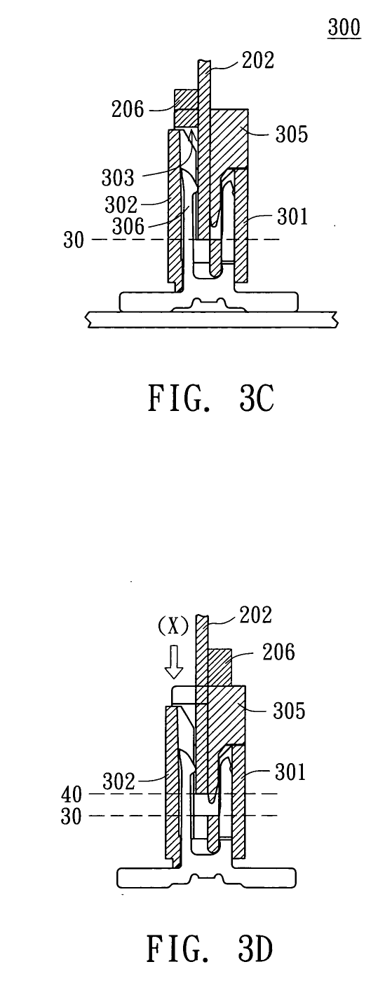

Referring to FIG. 3A, a lateral cross-sectional view of the socket is shown. The socket 300 has an actuator border 301 and a concave border 302. The actuator border 301 and the concave border 302 form a slot 303. FIG. 3B shows the top view of the socket. The socket 300 is provided with the cap-type flange 305 which is inverse U-shaped.

Referring to FIG. 2C and FIG. 3C, FIG. 3C shows a lateral cross-sectional view of the flexible flat cable plugged into the socket. The guider 206 is a rigid body so that the guider 206 is able to press against the concave border 302 after bearing the applied force evenly. Accordingly, the conductive portion 207 is completely plugged into the slot 303 for being electrically connected to the socket 300. At this time, a downward force is applied to the detachable cap-type flange 305 of the actuator border 301 for positioning the flexible flat cable 202, which enables the detachable cap-type flange 305 and the locating arm 306 jointly position the flexible flat cable 202. When inserting the flexible flat cable 202, the locating arm 306 is squeezed from the position shown in FIG. 3A into the position shown in FIG. 3C. As the locating arm 306 is elastic, the locating arm 306 is able to be against the flexible flat cable 202 positioned upright between the cap-type flange 305 and the locating arm 306. The assembled cap-type flange 305 provides the vertical surface of the cap-type flange 305 for being against by the flexible flat cable 202. Furthermore, the distance between the guider 206 and the end edge 209 enables the conductive portion 207 of the flexible flat cable 202 to be inserted into the slot 303 completely and makes conductive portion of the flexible flat cable 202 to reach the electric action point 30. Meanwhile, the bearing surface 221 located at the guider 206 is parallel to the end edge 209 of the body 204 substantially, so that the end edge 209 of the body 204 is plugged flush into the socket 300. Accordingly, the oblique insertion and the incomplete plugging of the body 204 into the socket 301 could be prevented.

Referring to FIG. 3D, a lateral cross-sectional view of the flexible flat cable reversely plugged into the socket is shown. When the bottom surface 210 of the flexible flat cable 202 is inserted towards the concave border 302 into the slot 303, the guider 206 is jammed in the cap-type flange 305 of the actuator border 301. Consequently, the flexible flat cable 202 is unable to be inserted into the slot 303, and the conductive portion located at the height (indicated by the dotted line 40) is unable to reach the electric action point 30. Users have to turn the flexible flat cable 202 to the other side around so as to locate the top surface 208 and the concave 302 at the same side, and the bottom surface 210 and the actuator border 301 at the same side. Therefore, the flexible flat cable 202 is able to be inserted into the slot 303 smoothly. The guider 206 disposed on the top surface 208 of the flexible flat cable 202 performs the function of preventing from the error insertion of the flexible flat cable 202.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A flexible flat cable for plugging into a socket, the socket comprising an actuator border and a concave border, the actuator border and the concave border forming a slot, the flexible flat cable comprising:
a body having a top surface, a bottom surface, and a conductive portion, the conductive portion being disposed on the top surface and extending to one end edge of the body; and
a guider disposed on the top surface of the body, wherein when the guider is against the concave border, the conductive portion is completely inserted into the slot for being electrically connected to the socket.

2. The flexible flat cable according to claim 1, wherein the guider has a bearing surface parallel to the end edge of the body substantially so that the end edge of the body inserted flush into the socket.

3. The flexible flat cable according to claim 1, wherein the guider is a rigid body so that the guider is against the concave border after bearing a force evenly.

4. The flexible flat cable according to claim 3, wherein the rigid body is made of plastic.

5. The flexible flat cable according to claim 1, wherein the guider is fixed on the top surface of the body by an adhesive.

6. The flexible flat cable according to claim 1, wherein the socket further comprises a cap-type flange disposed on the actuator border.

7. The flexible flat cable according to claim 6, wherein the cap-type flange is inverse U-shaped.

8. The flexible flat cable according to claim 1, wherein the flexible flat cable further comprises a supporting portion disposed on the bottom surface, and the supporting portion is corresponding to the conductive portion and the guider of the top surface substantially.

9. The flexible flat cable according to claim 8, wherein the supporting portion is an insulation tape.

10. The flexible flat cable according to claim 1, wherein the conductive portion comprises a plurality of conductors exposed outside the body.

11. A connecting apparatus comprising:
a socket comprising an actuator border and a concave border, the actuator border and the concave border forming a slot; and
a flexible flat cable plugged into the socket, the flexible flat cable comprising:
a body having a top surface, a bottom surface, and a conductive portion, the conductive portion being disposed on the top surface and extending to one end edge of the body; and
a guider disposed on the top surface of the body, wherein when the guider is against the concave border, the conductive portion is fully inserted into the slot for being electrically connected to the socket.

12. The apparatus according to claim 11, wherein the guider has a bearing surface, which is substantially parallel to the end edge of the body so that the end edge of the body inserted flush into the socket.

13. The apparatus according to claim 11, wherein the guider is a rigid body, so that the guider is against the concave border after bearing a force evenly.

14. The apparatus according to claim 13, wherein the rigid body is made of plastic.

15. The apparatus according to claim 11, wherein the guider is fixed on the top surface of the body by an adhesive.

16. The apparatus according to claim 11, wherein the socket further comprises a cap-type flange dispose on the actuator border.

17. The apparatus according to claim 16, wherein the cap-type flange is inverse U-shaped.

18. The apparatus according to claim 11, wherein the flexible flat cable further comprises a supporting portion disposed on the bottom surface, and the supporting portion is corresponding to the conductive portion and the guider of the top surface substantially.

19. The apparatus according to claim 18, wherein the supporting portion is an insulation tape.

20. The apparatus according to claim 11, wherein the conductive portion comprises a plurality of conductors exposed outside the body.
